(19) United States
(12) Patent Application Publication
(10) Pub. No.: US 2006/0170631 A1
(43) Pub. Date: Aug. 3, 2006

(54) Drive device and drive method of a light emitting display panel

(75) Inventors: Masato Togashi, Yonezawa-shi (JP); Toshihiko Aoki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/339,616

(22) Filed: Jan. 26, 2006

(30) Foreign Application Priority Data
Feb. 1, 2005 (JP) 2005-025280

(51) Int. Cl. G09G 3/32

(52) U.S. Cl. 345/82

(57) ABSTRACT

Provided is a drive device and a drive method of a light emitting display panel in which shadowing generated due to the lighting ratio of light emitting elements and a dimmer setting condition can be reduced to a level at which there is no problem for practical use. An analog video signal is supplied to a drive control circuit 11 and an A/D conversion circuit 12 and is converted into image data which corresponds to each pixel in the A/D conversion circuit 12 to be written in an image memory 13. The image data is read out of the image memory 13 for each scan, and the drive control circuit 11 obtains a rate of EL elements which are to be controlled to emit light (lighting ratio of light emitting elements for each scan). Based on the lighting ratio and dimmer setting data, precharge control data is read out of a look up table 14, and a precharge voltage VAM based on the precharge control data is supplied to a data driver 2. Thus, the precharge amount in the parasitic capacitances of the light emitting elements is changed, and as a result, the occurrence rate of shadowing can be restrained.

### BACKGROUND OF THE INVENTION

1. Field of the Invention

The present invention relates to a drive device and a drive method which can be suitably adopted in a passive matrix type light emitting display panel in which capacitive light emitting elements are employed, and more particularly to a drive device and a drive method of a light emitting display panel in which the occurrence rate of shadowing (horizontal crosstalk) generated due to a change of the lighting ratio of light emitting elements can be reduced to a level at which there is no problem for practical use.

2. Description of the Related Art

Demand for a display panel which has a high definition image display function and which can realize a thin shape and low power consumption has increased due to popularity of cellular telephones, personal digital assistants (PDAs), and the like, and conventionally a liquid crystal display panel has been adopted in many products as the one which meets the needs thereof. Meanwhile, these days an organic EL (electroluminescent) element whose characteristic as being a self light emitting type element is best used has been put to practical use, and this have attracted attention as a next generation display panel in place of the conventional liquid crystal display panel. A background thereof is that by employing, in a light emitting layer of the element, an organic compound by which an excellent light emission characteristic can be expected, a high efficiency and a long life by which practical use is possible have been advanced.

The above-described organic EL element is constructed for example by laminating a transparent electrode (anode electrode) made of ITO, a light emission functional layer, and a metal electrode (cathode electrode) made of an aluminum alloy or the like one by one basically on a transparent substrate such as of glass or the like. The light emission functional layer may be a single light emitting layer made of an organic compound, or a two layer structure composed of an organic positive hole transport layer and a light emitting layer, or a three layer structure composed of an organic positive hole transport layer, a light emitting layer, and an organic electron transport layer, or a multilayer structure in which an positive hole injection layer and an electron injection layer are inserted between the transparent electrode and the positive hole transport layer and between the metal electrode and the electron transport layer, respectively. The light generated in the light emission functional layer is discharged to the outside via the transparent electrode and the transparent substrate.

The organic EL element can be replaced electrically by a structure composed of a light emission component having a diode characteristic and a parasitic capacitance component which is connected in parallel to this light emission component, and thus the organic EL element has been said to be a capacitive light emitting element. When a light emission drive voltage is applied to this organic EL element, at first, electrical charges corresponding to the electric capacity of this element flow into the electrode as a displacement current and are accumulated. It can be considered that when the drive voltage then exceeds a determined voltage (light emission threshold voltage=Vth) peculiar to this element, current begins to flow from an electrode (anode side of the diode component) to the light emission functional layer so that the element emits light at an intensity proportional to this current.

Meanwhile, regarding the organic EL element, due to reasons that the voltage-intensity characteristic thereof has a high dependency on temperature changes while the current-intensity characteristic thereof is stable with respect to temperature changes and that degradation of the organic EL element is enormous in a case of receiving an excess current so that the light emission lifetime thereof is shortened, a constant current drive is performed in general. As a display panel employing such organic EL elements, a passive drive type display panel in which elements are arranged in a matrix has already been put to a practical use partly.

FIG. 1 shows one example of a conventional passive matrix type display panel and its drive circuit, and this shows an aspect of cathode line scan/anode line drive. That is, m data lines (hereinafter these will be referred to also as anode lines) A1-Am are arranged in a vertical direction, n scan lines (hereinafter these will be referred to also as cathode lines) K1-Kn as are arranged in a horizontal direction, and organic EL elements E11-Emn represented by parallel coupling bodies which are designated by symbols of diodes and capacitors are arranged at portions at which the anode lines intersect the cathode lines (in total, m×n portions) to construct a display panel 1.

In the respective EL elements E11-Emn constituting pixels, one ends thereof (anode terminals in the equivalent diodes of the EL elements) are connected to the anode lines and the other ends thereof (cathode terminals in the equivalent diodes of the EL elements) are connected to the cathode lines, corresponding to the respective intersection positions between the anode lines A1-Am extending along the vertical direction and the cathode lines K1-Kn extending along the horizontal direction. Further, the respective anode lines A1-Am are connected to an anode line drive circuit 2 which is provided as a data driver, and the respective cathode lines K1-Kn are connected to a cathode line scan circuit 3 as a scan driver, so as to be driven respectively.

In the anode line drive circuit 2, provided are constant current sources I1-Im as lighting drive power sources, operating by utilizing a drive voltage supplied from a drive voltage source VH and drive switches Sa1-Sam as switching means, and by allowing the drive switches Sa1-Sam to be connected to the constant current sources I1-Im sides, current from the constant current sources I1-Im is supplied as drive current to respective EL elements E11-Emn arranged corresponding to the cathode lines. The drive switches Sa1-Sam are constructed such that a voltage from a voltage source VAM or a reference potential point as a non-lighting-drive power source (in this example, a ground potential GND) can be supplied to the respective EL elements E11-Emn arranged corresponding to the cathode lines.

Meanwhile, in the cathode line scan circuit 3, scan switches Sk1-Skn as switching means are provided corresponding to the respective cathode lines K1-Kn, so that either of a reverse bias voltage which functions as a non-scan-selection potential and which is provided from a reverse bias voltage source VM employed for mainly preventing crosstalk light emission or a scan selection potential (the ground potential GND as the reference potential point in this example) can be supplied to a corresponding cathode line.

Control signals are supplied to the anode line drive circuit 2 and the cathode line scan circuit 3 respectively from a light emission control circuit 4 including a CPU and the like via a control bus, and based on a video signal to be displayed, switching operations of the scan switches Sk1-Skn and the drive switches Sa1-Sam are performed. Thus, the constant current sources I1-Im are connected to desired anode lines while a cathode scan line is set at the ground potential at a predetermined cycle based on the video signal, and the respective EL elements E11-Emn are selectively illuminated, so that an image based on the video signal is displayed on the display panel 1.

In the state shown in FIG. 1, the second cathode line K2 is set at the ground potential to become in a scan state, and at this time the reverse bias voltage from the reverse bias voltage source VM is applied to the respective cathode lines K1, K3-Kn of a non-scan state. Here, where the forward voltage of the EL element in a scan light emission state is Vf, respective potentials are set to establish a relationship of [(forward voltage Vf)−(reverse bias voltage VM)]<(light emission threshold voltage Vth), and thus the respective EL elements connected to intersection points between driven anode lines and cathode lines which are not selectively scanned are prevented from emitting crosstalk light.

Meanwhile, the organic EL elements arranged in the display panel 1 respectively have parasitic capacitances as described above, and these elements are arranged at intersection positions between the anode lines and the cathode lines in a matrix pattern. Thus, for example, in an example of a case where several tens of EL elements are connected to one anode line, from the viewpoint of this anode line, a synthesized capacitance of several hundred times the each parasitic capacitance or greater is connected to the anode line as a load capacitance. This synthesized capacitance increases drastically as the size of the matrix increases.

Therefore, at a beginning of a lighting scan period of EL elements, current from the constant current sources I1-Im provided via the anode lines is consumed for charging the synthesized load capacitance, and a time lag occurs for charging the load capacitance until the voltage satisfactorily exceeds the light emission threshold voltage (Vth) of the EL element. Therefore, a problem arises in that a start of light emission of the EL element delays (slows down). In particular, in the case where the constant current sources I1-Im are employed as drive sources for the EL elements as described above, since the constant current source is a high impedance output circuit on the principle of operation, the current is restricted so that the start of light emission of the EL element delays drastically.

This deteriorates the lighting time rate of the EL element, and thus there is a problem that the substantial light emission intensity of the EL element is decreased. Thus, in order to eliminate the delay of the start of light emission of the EL element by the parasitic capacitance, in the structure shown in FIG. 1, utilizing the reverse bias voltage VM, an operation in which charging an EL element which is subjected to lighting is performed.

FIG. 2 shows a lighting drive operation of the EL element including a reset period in which the amount of charges charged in the parasitic capacitance of the EL element which is subjected to lighting is made zero. FIG. 2A shows a scan synchronization signal, and in this example, the reset period and a constant current drive period are set in synchronization with the scan synchronization signal.

FIGS. 2B and 2C show electrical potentials applied to a lighting line and a non-lighting line in the anode lines connected to the anode driver (anode line drive circuit) 2 during the respective periods. FIGS. 2D2D and 2E show electrical potentials applied to a scan line and a non-scan line in the cathode lines connected to the cathode driver (cathode line scan circuit) 3 during the respective periods.

During the reset period shown in FIG. 2, the drive switches Sa1-Sam as switching means provided in the anode driver 2 allow the electrical potential from the voltage source VAM to be supplied to the anode line (lighting line) which corresponds to EL elements which are controlled to be lit as shown in FIG. 2B. Further, control is performed such that the ground potential GND as the reference potential of the circuit is supplied to the anode line (non-lighting line) which corresponds to EL elements which are subjected to non-lighting as shown in FIG. 2C.

Meanwhile, during the reset period the cathode driver 3, by means of the scan switches Sk1-Skn provided therein as switching means, applies the reverse bias voltages VM to the cathode line (scan line) subjected to scanning and the cathode line subjected to non-scanning (non-scan line) as shown in FIGS. 2D and 2E, respectively.

During the constant current drive period that is a lighting period of the EL element, a constant current is supplied from the constant current sources I1-Im to the anode line (lighting line) which corresponds to EL elements subjected to lighting by means of the drive switches Sa1-Sam as shown in FIG. 2B. The ground potential GND as the reference potential is set on the anode line (non-lighting line) which corresponds to EL elements subjected to non-lighting as shown in FIG. 2C.

Meanwhile, during the constant current drive period the cathode driver 3 controls the scan switches Sk1-Skn provided therein such that the cathode line (scan line) subjected to scanning is set at the ground potential GND as shown in FIG. 2D and that the reverse bias voltage VM is applied to the cathode line (non-scan line) subjected to non-scanning as shown in FIG. 2E.

Immediately after shifting to the above-described constant current drive period, the charging amount of the parasitic capacitances of all EL elements which are connected to the lighting line is zero. Thus, current transitionally flows from the reverse bias voltage source VM to EL elements subjected to lighting via EL elements which has not been scanned, and charging to the parasitic capacitances of EL elements subjected to lighting is performed rapidly. As a result, start of light emission of EL elements subjected to lighting is relatively rapidly performed.

A passive drive type display device which precharges EL elements which are to be driven to be lit, utilizing the reverse bias voltage, as described above, has been disclosed in Japanese Patent Application Laid-Open No. H 9-232074.

In the passive drive type display device having the above-described structure, it has been known that a so-called shadowing (horizontal crosstalk) occurs depending on the lighting ratio of the EL element, in that variations in light emission intensities occur among EL elements corresponding to respectives can lines whose lighting ratios are different. FIGS. 3 and 4 explain conditions that the above-mentioned shadowing occurs.

FIGS. 3A and 3B show states in which voltages are applied to the EL elements during the reset period and the constant current drive period, respectively, in accordance with the above-described timing charts shown in FIG. 2. FIG. 3 exemplifies a case where the lighting ratio of the EL element is 100%. For convenience of illustration, in FIG. 3 shown are supplying states of electrical potentials to respective EL elements which correspond to first, second, and mth anode lines and first, second, and nth cathode lines.

As shown in FIG. 3A, during the reset period all scan switches Sk1-Skn are connected to the VM side, and the reverse bias voltage VM is applied to the respective scan lines K1-Kn. All drive switches Sa1-Sam are connected to the VAM side. Here, the reverse bias voltage VM and the voltage source VAM are in a relationship of VM=VAM. Accordingly, during the reset period shown in FIG. 3A, potential differences of both ends of all EL elements become zero, and the electrical charge amount charged in the parasitic capacitances of the EL elements becomes zero.

Meanwhile, during the constant current drive period, as shown in FIG. 3B, for example the first scan line K1 which is to be scanned for lighting is set at the ground potential GND via the scan switch Sk1, and continuously the reverse bias voltage VM is applied to other scan lines via the scan switches Sk2-Skn. At this time all drive switches Sa1-Sam are connected to the constant current sources I1-Im.

Thus, lighting drive currents from the respective constant current sources I1-Im are supplied to the respective EL elements which are connected to the first scan line K1. At this time, the current flowing from the reverse bias potential VM into the parasitic capacitances of the EL elements which have not been scanned flows transitionally into the anode sides of the EL elements which are subjected to lighting through the respective anode lines so that charging for the parasitic capacitances of the EL elements which are subjected to lighting is performed quickly. As a result, light emission starts of the EL elements subjected to lighting are performed relatively quickly.

Next, FIG. 4 shows an example of operations of a case where the lighting ratio of the EL element is decreased, and FIGS. 4A and 4B show supplying states of electrical potentials to the respective EL elements during the reset period and the constant current drive period, respectively, similarly to FIG. 3. However, in this FIG. 4, shown is an example in which the EL elements corresponding to the first and second anode lines are not lit and in which the EL elements corresponding to the mth anode line are lit, and therefore in the scope shown in this FIG. 4, the lighting ratio of the EL element can be said to be 33%.

During the reset period, as shown in FIG. 4A, the reverse bias voltage VM is applied to the respective scan lines K1-Kn. The first and second anode lines A1, A2 are connected to the ground potential GND, and the mth anode line Am is connected to the VAM side. Thus, potential differences of both ends of the respective EL elements which are connected to the mth anode line Am become zero, and the electrical charge amount charged in the parasitic capacitances of the respective EL elements which are connected to Am becomes zero. Meanwhile, the reverse bias voltage by the VM is applied to the respective EL elements which are connected to the first and second anode lines A1, A2 which are controlled to be in a non-lighting state so as to be charged in the polarity shown in the drawing.

Then, during the constant current drive period, as shown in FIG. 4B, for example the first scan line K1 which is to be scanned for lighting is set at the ground potential GND, and continuously the reverse bias voltage VM is applied to the other scan lines. At this time the first and second anode lines A1, A2 which are controlled to be in the non-lighting state are set at the ground potential GND, and the mth anode line Am which is controlled for lighting is connected to the constant current source Im side.

Thus, the lighting drive current from the constant current source Im is supplied to the lighting target EL element which is connected to the first scan line K1 and the mth anode line Am. At this time, the current flowing from the reverse bias potential VM into the parasitic capacitances of the EL elements which have not been scanned flows transitionally into the anode side of the EL element which is subjected to lighting through the respective anode line so that charging for the parasitic capacitance of the EL element which is subjected to lighting is performed quickly. As a result, the light emission start of the EL element which is subjected to lighting is performed relatively rapidly.

Here, as described above, the reverse bias by VM has already been charged in respective EL elements which are subjected to non-lighting, and since its state does not change, a transitional current flowing from the reverse bias VM via the anode lines A1, A2 which are not subjected to lighting becomes almost zero. As a result, potential decreases of the reverse bias potentials in the respective cathode lines K2-Kn of the non-scan state rarely occur, and current which transitionally flows into the anode side of the EL element of the scan lighting target via the respective cathode lines K2-Kn of the non-scan state and the anode line Am which is to be the lighting target increases compared to that of the state shown in FIG. 3B. Thus, the degree of raising of the intensity of the light emission first stage of the EL element which is a scan lighting target becomes more prominent than that of the example shown in FIG. 3.

FIG. 5 schematically shows an example of shadowing (horizontal crosstalk) generated by the above-mentioned interaction. In the display pattern shown in FIG. 5, the cross hatched “A” portion shows an area on which EL elements are in the non-lighting state, and the “B” and “C” portions show areas on which EL elements are in a lighting state. As shown as “A” in FIG. 5, in a case where the ratio of non-lighting elements is large for each scan line (a case where the lighting ratio is small), “bright horizontal crosstalk” in which the portion shown by “B” emits light more brightly than the portion shown by “C” occurs.

The example described above is based on a VM reset method in which the reverse bias voltage of the VM is applied to EL elements controlled to be the non-lighting state in a reset operation mode. On the other hand, in a case by a GND reset method in which both ends of EL elements controlled to be in the non-lighting state are set at the ground potential GND in the reset operation mode, “dark horizontal crosstalk” in which the portion shown by “B” in FIG. 5 emits light darker than the portion shown by “C” occurs. The shadowing occurs in a variety of aspects due to a primary factor such as the display pattern of a display panel, a time constant, and the like.

Meanwhile, it has been known that the lower the setting of the dimmer value in a dimmer display in which entire contrast of the display panel is controlled, the more prominent the occurrence rate of the shadowing. It is contemplated that this is because the lower the setting of the dimmer value, the shorter the light emission time of EL elements during one scan period, or this is because due to smallness of the value of drive current, contribution of electrical charges flowing via the parasitic capacitances of the EL elements which have not been scanned and via the data line of the EL element which has been scanned becomes relatively high.

### SUMMARY OF THE INVENTION

The present invention has been developed, paying attention to the problem of shadowing generated particularly in a case where the lighting ratio of EL elements for each scan line is low as described above and the problem that the lower the setting of the dimmer value by dimmer control, the more prominent the shadowing occurs, and it is an object of the present invention to provide a drive device and a drive method of a light emitting display panel in which this shadowing can be reduced to a level at which this does not become a problem in practical use.

A preferred basic aspect of a drive device according to the present invention which has been developed in order to solve the above-described problem is a drive device for implementing light emission drive for a passive matrix type display panel provided with a plurality of scan lines and a plurality of data lines which intersect one another and light emitting elements respectively connected between said respective scan lines and respective data lines at intersection positions between said respective scan lines and respective data lines, comprising a switching means of a scan driver side for setting said respective scan lines at a scan selection potential or a non-scan selection potential and a switching means of a data driver side for connecting said respective data lines to a lighting drive power source or a non-lighting drive power source, characterized in that at least a reset period, a precharge period, and a lighting period of said light emitting elements are set during one scan period of said display panel, and during said precharge period, a voltage from a precharge power source can be applied to the respective light emitting elements in a forward direction via all of said respective data lines and scan lines.

A preferred basic aspect of a drive method according to the present invention which has been developed in order to solve the above-described problem is a drive method for implementing light emission drive for a passive matrix type display panel provided with a plurality of scan lines and a plurality of data lines which intersect one another and light emitting elements respectively connected between said respective scan lines and respective data lines at intersection positions between said respective scan lines and respective data lines, characterized in that at least a reset period, a precharge period, and a lighting period of said light emitting elements are set during one scan period of said display panel, and during said precharge period, a voltage from a precharge power source can be applied to said respective light emitting elements in a forward direction via all of said respective data lines and scan lines to implement a charge operation in which parasitic capacitances of said light emitting elements are charged in the forward direction.

### BRIEF DESCRIPTION OF THE DRAWINGS

FIG. 1 is a circuit structure diagram showing one example of a conventional passive matrix type display panel and its drive circuit;

FIG. 2 is timing charts explaining a lighting drive operation in the display panel shown in FIG. 1;

FIG. 3 is circuit structure diagrams explaining operations of a case where the lighting rate of light emitting elements according to the timing charts shown in FIG. 2 is high;

FIG. 4 is circuit structure diagrams explaining operations of a case where the lighting rate of light emitting elements according to the timing charts shown in FIG. 2 is low;

FIG. 5 is a schematic view showing an example in which shadowing occurs;

FIG. 6 is timing charts explaining a lighting drive operation in a drive device according to the present invention;

FIG. 7 is a circuit structure diagram showing a state of a reset period in the drive device according to the present invention;

FIG. 8 is a circuit structure diagram showing a state of a precharge period similarly;

FIG. 9 is a circuit structure diagram showing a state of a lighting period similarly; and

FIG. 10 is equivalent circuit diagrams explaining one reason that shadowing occurs.

### DESCRIPTION OF THE PREFERRED EMBODIMENT

A drive device of a light emitting display panel according to the present invention will be described below based on an embodiment shown in the drawings. In the embodiment described below, parts which perform the same functions as those of constituent elements shown in the respective drawings already described are designated by the same reference numeral.

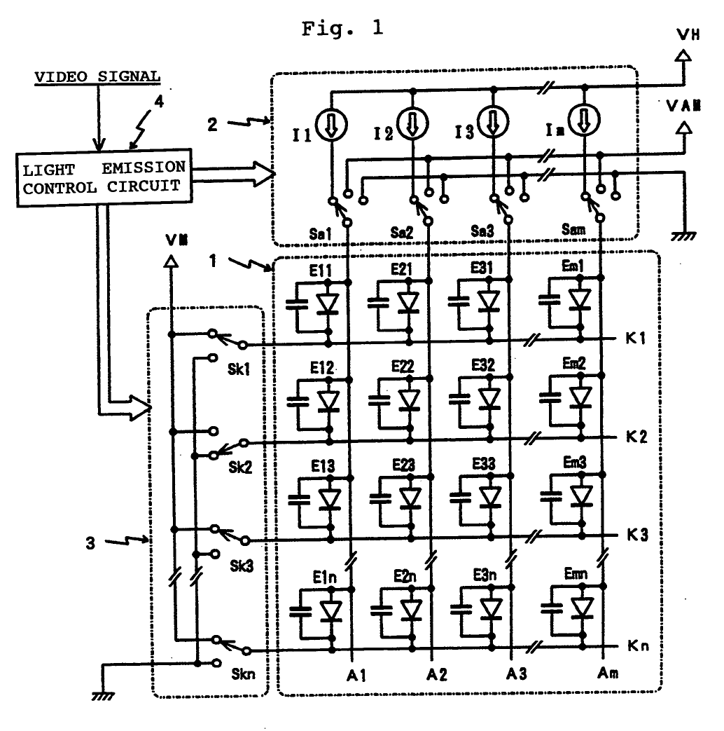

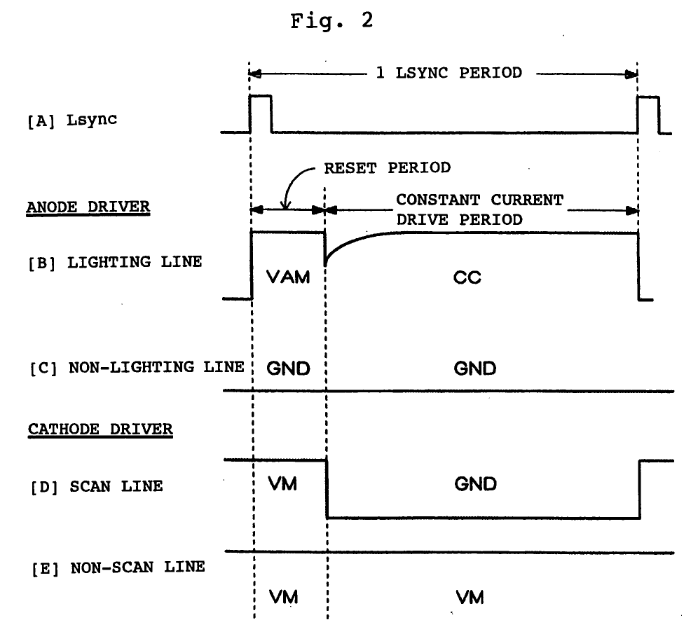

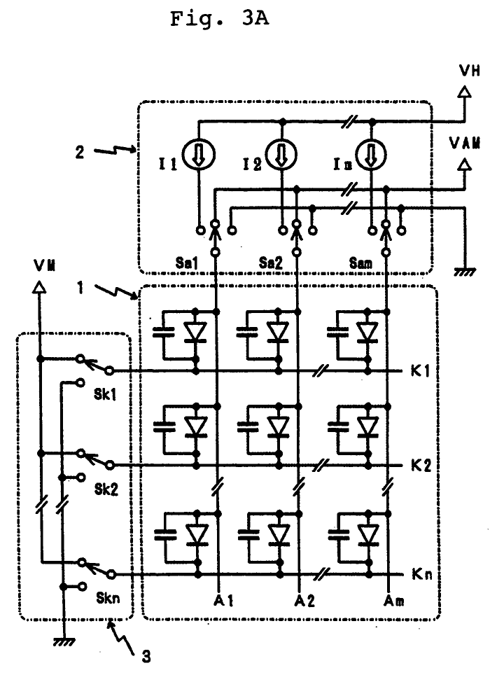

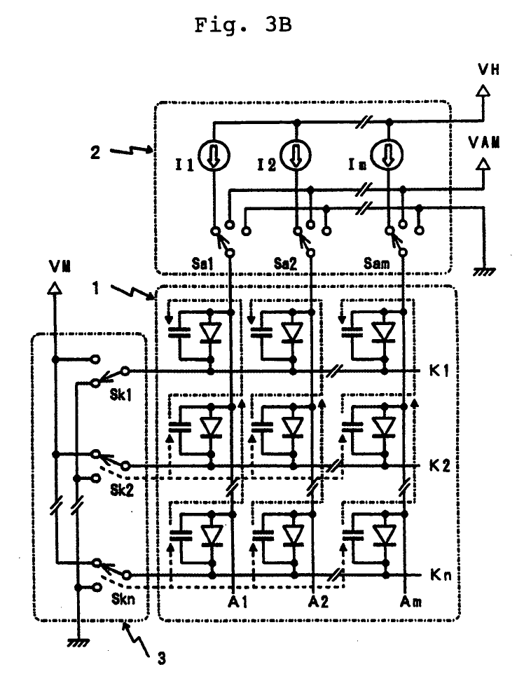

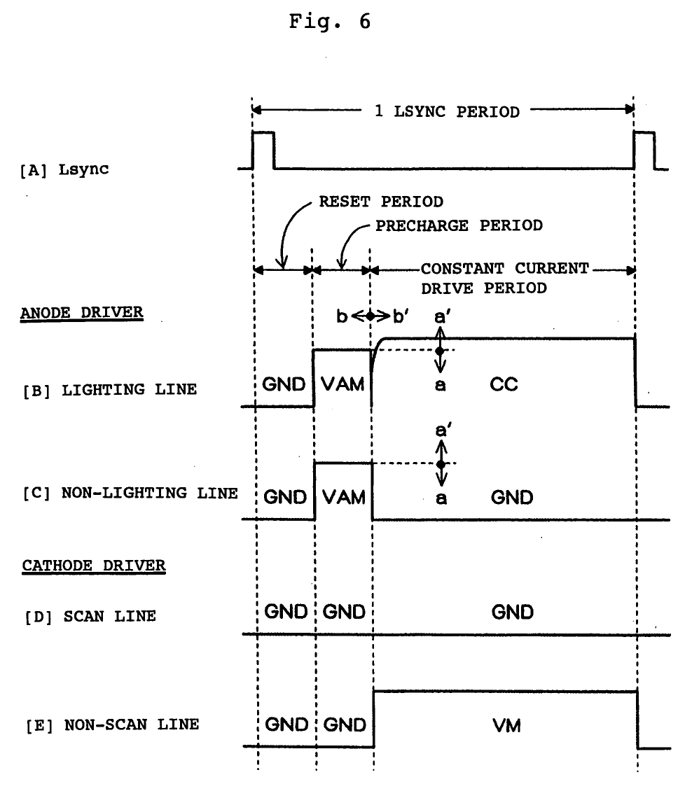

As a drive device according to the present invention, the same circuit structure as that of shown in FIG. 1 already described is adopted basically. In the drive device according to the present invention, a reset period, a precharge period, and a constant current drive period (lighting period) are set for each one scan period in synchronization with a scan synchronization signal shown in FIG. 6A.

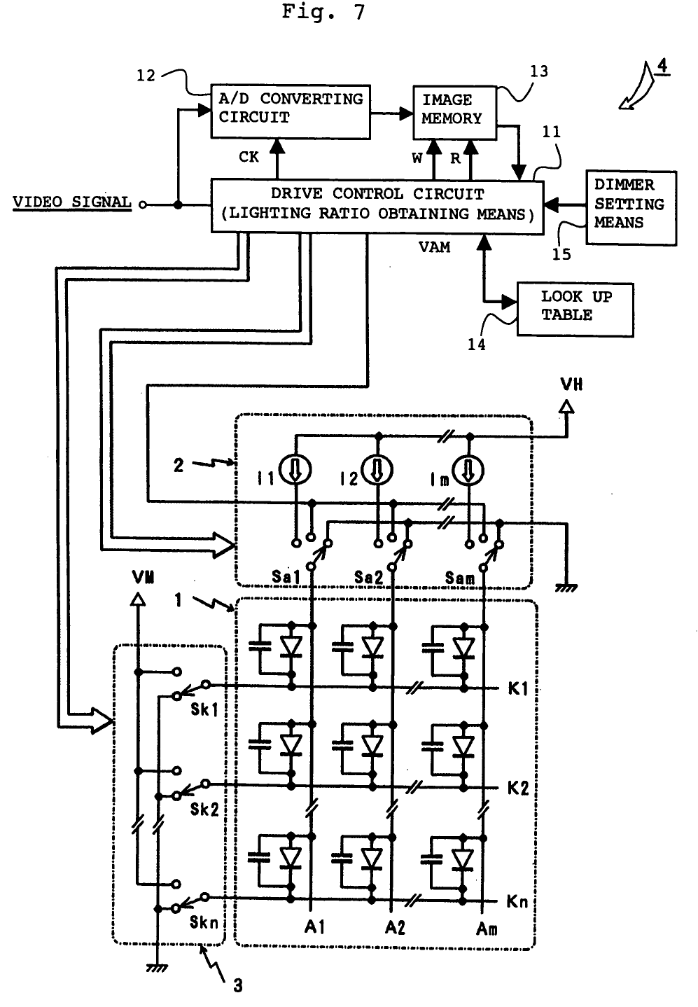

Timing charts shown in FIG. 6 are shown in an expression similar to that shown in FIG. 2 already described. Respective drive switches Sa1-Sam in a data driver (anode driver) 2 and scan switches Sk1-Skn in a scan driver (cathode driver) 3 in respective FIGS. 7-9 correspond to selection states of respective electrical potentials during the respective reset period, precharge period, and lighting period shown in FIG. 6.

First, during the reset period, as shown in FIGS. 6B to 6E, all of the respective drive switches Sa1-Sam and respective scan switches Sk1-Skn select the ground potential GND, and thus electrical charges accumulated in the parasitic capacitances of the respective EL elements are discharged, so that they become in a reset state.

During the precharge period which continues after the reset period, all of the respective drive switches Sa1-Sam in the anode driver side select the precharge voltage source VAM side as shown in FIGS. 6B, 6C, and all of the respective scan switches Sk1-Skn in the cathode driver side select the ground potential GND as shown in FIGS. 6D, 6E. Thus, the voltage from the precharge voltage source VAM is applied to the respective EL elements in a forward direction via all of the respective data lines and scan lines, and the precharge voltage is charged in the parasitic capacitances of the respective EL elements in the forward direction.

In this case, it is preferred that the voltage of the precharge voltage source VAM is set at an electrical potential which does not exceed the voltage obtained by adding the light emission threshold voltage Vth of the EL element to a scan selection potential (the ground potential GND in this embodiment). With such a potential relationship, the respective EL elements can be prevented from being driven to emit light by applying of the voltage by the precharge voltage source VAM. In a case where the voltage of the precharge voltage source VAM is set at an electrical potential which exceed the voltage obtained by adding the light emission threshold voltage Vth of the EL element to the scan selection potential, by setting the precharge period at a short period, the respective EL elements can be prevented from being driven to emit light by applying of the voltage by the precharge voltage source VAM.

Then, the period shifts to the lighting period (constant current drive period), and by means of the drive switches Sa1-Sam, constant currents are supplied from constant current sources I1-Im to the anode lines (lighting lines) which correspond to EL elements which are to be lit as shown in FIG. 6B. An anode line (non-lighting line) which corresponds to EL elements which are not to be lit is set at the ground potential GND as shown in FIG. 6C. FIG. 9 showing the state of the lighting period shows an example in which the anode lines A1, A2 a are allowed to be lighting lines and in which the anode line Am is allowed to be a non-lighting line.

During control of the lighting period, the cathode driver 3 is controlled such that a cathode line (scan line) which is subjected to scanning is set at the ground potential GND as shown in FIG. 6D and that the voltage from the reverse bias voltage source VM is applied to cathode lines (non-scan lines) which are subjected to non-scanning as shown in FIG. 6E, by means of the scan switches Sk1-Skn provided in the cathode driver 3. FIG. 9 which shows the state of the lighting period shows an example in which the first cathode line K1 is the scan line and in which other cathode lines K2-Kn are the non-scan lines.

According to a lighting drive operation of EL elements based on the timing charts shown in FIG. 6 described above, during the precharge period which continues after the reset period, the voltage from the precharge voltage source VAM is applied to the parasitic capacitances of all respective EL elements in the display panel 1 in the forward direction. Thus, a charging operation is performed uniformly for the parasitic capacitances of the respective EL elements.

During the lighting period which continues thereafter, the light emission drive current is supplied from the constant current sources I1-Im provided as the lighting drive sources to the EL elements which are lit and displayed. At this time, since the parasitic capacitances of the EL elements which are lit and displayed have already been precharged in the forward direction, the voltages of the EL elements which are to be lit and displayed raise to the light emission threshold voltage Vth or higher immediately after the constant current drive, so that instantly light emission is started.

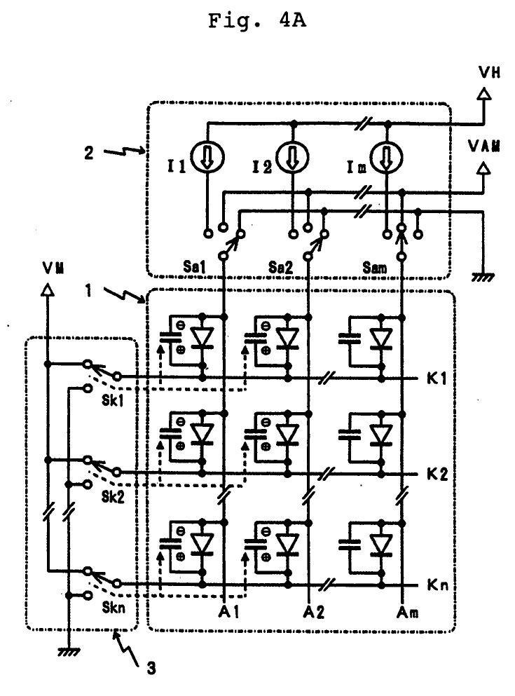

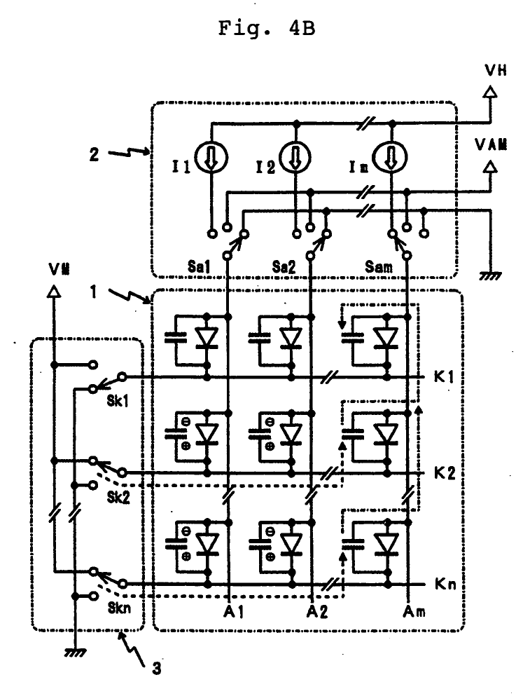

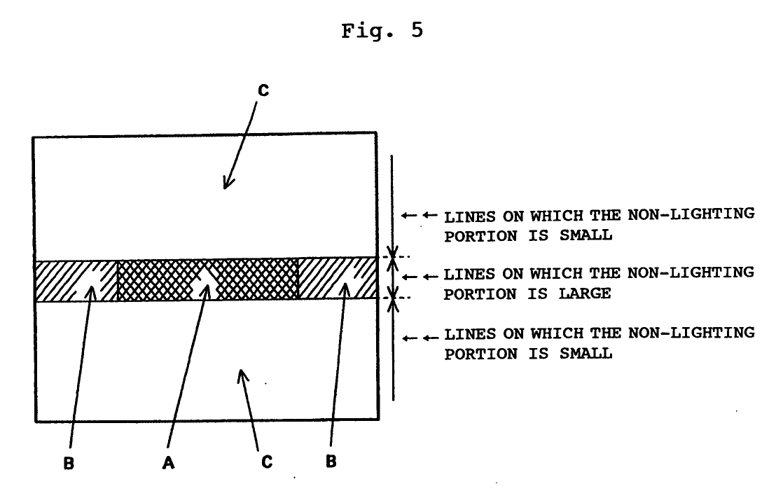

In this case, during the precharge period, due to the state in which the voltage from the precharge voltage source VAM is charged in the forward direction in the parasitic capacitances of all EL elements, particularly as described based on FIG. 4B, the rate at which a charging time constant (load of capacitance) of the entire display panel changes in accordance with the lighting rate of EL elements for each one scan, seen from the reverse bias voltage source VM side, is reduced, and a primary factor that the amount of current which transitionally flows into the anode side of the EL element which is subjected to lighting changes in response to the lighting rate to cause shadowing can be eliminated.

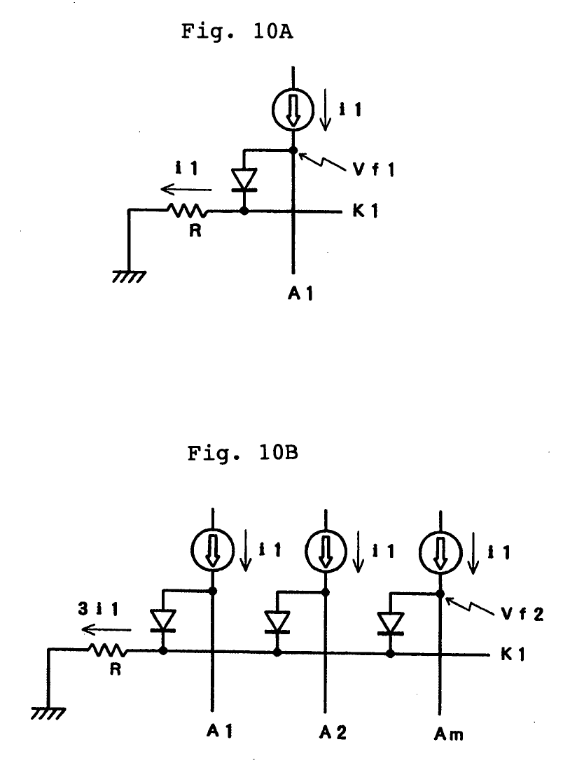

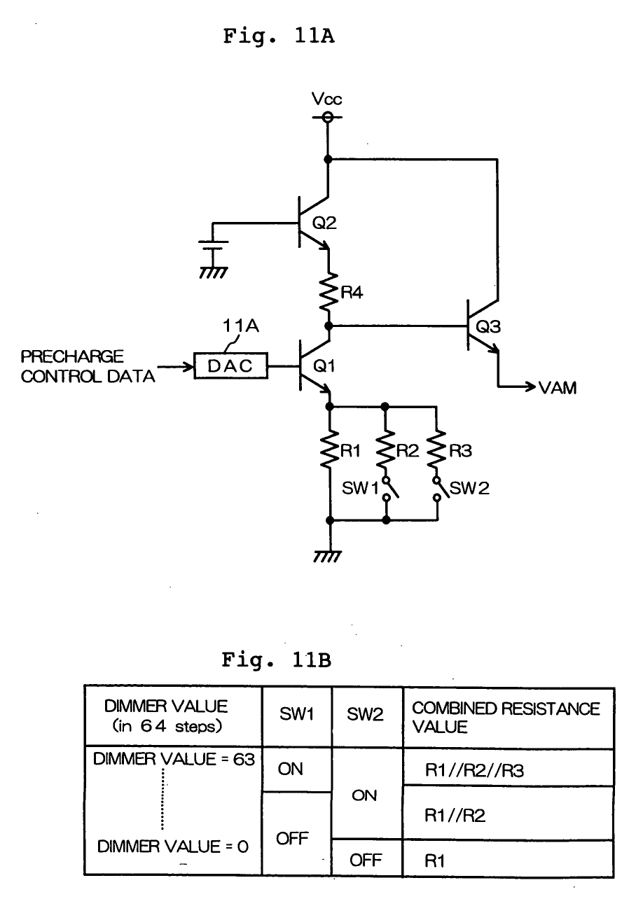

However, due to another reason described below, there is a problem that the shadowing still occurs in response to the lighting rate of EL elements for each scan line. FIG. 10 explains an example that the shadowing occurs due to another reason, and FIG. 10A and FIG. 10B equivalently show a case where the lighting rate of EL elements is low and a case where the lighting rate is high, respectively. In FIG. 10, reference numeral i1 represents a current value supplied from the constant current source which functions as a lighting drive source for EL elements, and reference numeral R represents a wiring resistance from a scan line to a scan selection potential (ground potential GND).

FIG. 1A shows a state in which, corresponding to the first scan line K1 which becomes in a scan selection state, an EL element connected to the first data line A1, that is, one EL element, is driven to emit light, and a level Vf1 of the anode terminal of the EL element of this case can be designated by the following equation (1) where the threshold voltage of the element is Vth:
Vf1=i1−R+Vth (equation 1)

FIG. 10B shows a state in which, corresponding to the first scan line K1 which becomes in the scan selection state, respective EL elements connected to the first, second, and mth data lines A1, A2, Am, that is, three EL elements, are driven to emit light, and a level Vf2 of the anode terminal of the EL element of this case can be designated by the following equation (2) where the threshold voltage of the element is Vth similarly:
Vf2=3·i1·R+Vth (equation 2)

Since the respective EL elements are driven by constant currents, due to influence of a voltage drop by the wiring resistance R from the scan line to the scan selection potential (ground potential GND), the higher the lighting rate, the higher the voltage level Vf2 of the anode terminal of the EL element which is driven to be lit, and in a case where the lighting rate is low, the voltage level Vf1 in the anode terminal becomes low. In addition, in a case where the above-mentioned dimmer control is conducted by a current drive method, since the current value from the constant current source which is provided as the lighting drive source changes in accordance with the dimmer control, the voltage level in the anode terminal of the above-described EL element also changes.

Since the voltage level in the anode terminal of the EL element changes by the effect described above in response to the lighting ratio and the dimmer control, a difference occurs between the voltage level in the anode terminal of the EL element and the fixed precharge voltage source VAM supplied from the above-described precharge voltage source VAM, and this becomes a primary factor by which shadowing occurs.

In order to restrain the occurrence of shadowing caused by the above-described primary factor, control should be performed such that the voltage level from the precharge voltage source VAM is changed in response to the voltage level in the anode terminal of the EL element which changes due to the lighting ratio of the EL element and the dimmer control. In this case, it is preferred that the voltage level in the anode terminal of the EL element which changes due to the lighting ratio and the dimmer control is allowed to coincide with the voltage value of the VAM.

Thus, in a light emission control circuit 4 shown in FIGS. 7-9, a structure to restrain shadowing generated due to the above-described reason is shown. As shown in FIGS. 7-9, an analog video signal is supplied to a drive control circuit 11 and an analog/digital (A/D) conversion circuit 12 which constitute the light emission control circuit 4. The drive control circuit 11 generates a clock signal CK for the A/D conversion circuit 12 and a write signal W and a read signal R for an image memory 13 based on horizontal and vertical synchronization signals in the analog video signal.

The drive control circuit 11 outputs a switching signal for the drive switches in the data driver 2 shown in FIGS. 7-9 and outputs a scan switching signal for the scan driver 3, based on the horizontal and vertical synchronization signals.

The A/D conversion circuit 12 samples an inputted analog signal based on the clock signal supplied from the drive control circuit 11 and converts this to corresponding image data for each pixel to supply this to the image memory 13. The image memory 13 operates to sequentially write respective image data supplied from the A/D conversion circuit 12 in the image memory 13 by the write signal W provided from the drive control circuit 11.

In a case where a frame memory is adopted as the image memory 13, writing of data of one screen (m rows and n columns) in the display panel 1 is performed by the above-described writing operation. After writing of data of one screen is completed, image data is read from the memory 13 for each one row (one scan) from the first row to nth row of the scan lines by the read signal R supplied from the drive control circuit 11. The drive control circuit 11 operates to obtain a rate PN of EL elements which are to be controlled to emit light (lighting ratio of EL elements for each scan), from the image data for each row. In other words, the drive control circuit 11 functions as a lighting ratio obtaining means of EL elements.

The drive control circuit 11 is constructed such that dimmer control data is supplied from a dimmer setting means 15, and such that by this dimmer control data, dimmer display of D stage (D=1−d) is performed in the display panel 1. This dimmer setting means 15 is constructed such that in some cases a dimmer value may be set manually and in some cases it may be set automatically while an outside light is received in a mobile device and the like.

The drive control circuit 11 is constructed to find precharge control data corresponding to the lighting ratio PN for each scan from a look up table 14 as one aspect so that the precharge voltage VAM which is generated based on the precharge control data which has been found from this look up table 14 is supplied from the drive control circuit 11 to the data driver 2.

In particular, a variable voltage circuit as shown in FIG. 11A, for example, is provided in the above-mentioned drive control circuit 11, and the precharge voltage VAM is generated by the variable voltage circuit. In FIG. 11(A), the precharge control data corresponding to the lighting rate PN for each the above-mentioned scan is inputted into a DAC (D/A converter) circuit 11A. Output of the DAC circuit 11A is supplied to a base of an npn transistor Q1, and parallel load resistors R1-R3 are connected to an emitter of the transistor Q1. Among these, the resistor R2 is provided with a switch SW1 for choosing grounding/opening (ON/OFF), and the resistor R3 is provided with a switch SW2 for choosing grounding/opening (ON/OFF). On the other hand, as shown, a resistor R4 and an npn transistor Q2 which functions as a low-voltage device are connected in series between a collector of the transistor Q1 and a supply voltage Vcc.

Further, by referring to a switch control table as shown in FIG. 11B, the drive control circuit 11 controls and switches the above-mentioned switches SW1 and SW2. A combination of change operations of the switches SW1 and SW2 corresponding to respective values in 64 steps of dimmer values is set as shown in the switch control table. In other words, by referring to the switch control table, any one of combined resistance values of the three states where the resistors R1, R2, and R3 (load resistance of the emitter of the transistor Q1) are combined is determined with respect to a dimmer value inputted from a dimmer setting means 15.

Such a structure allows a collector potential of the transistor Q1 to be controlled by the output from the DAC circuit 11 which varies with the lighting rate PN, and further controlled by the load resistance of the emitter determined by the set dimmer value. And the collector potential of the transistor Q1 is supplied to a base of the npn transistor Q3, and outputted as a precharge voltage VAM through an emitter of the transistor Q3 which functions as an emitter follower.

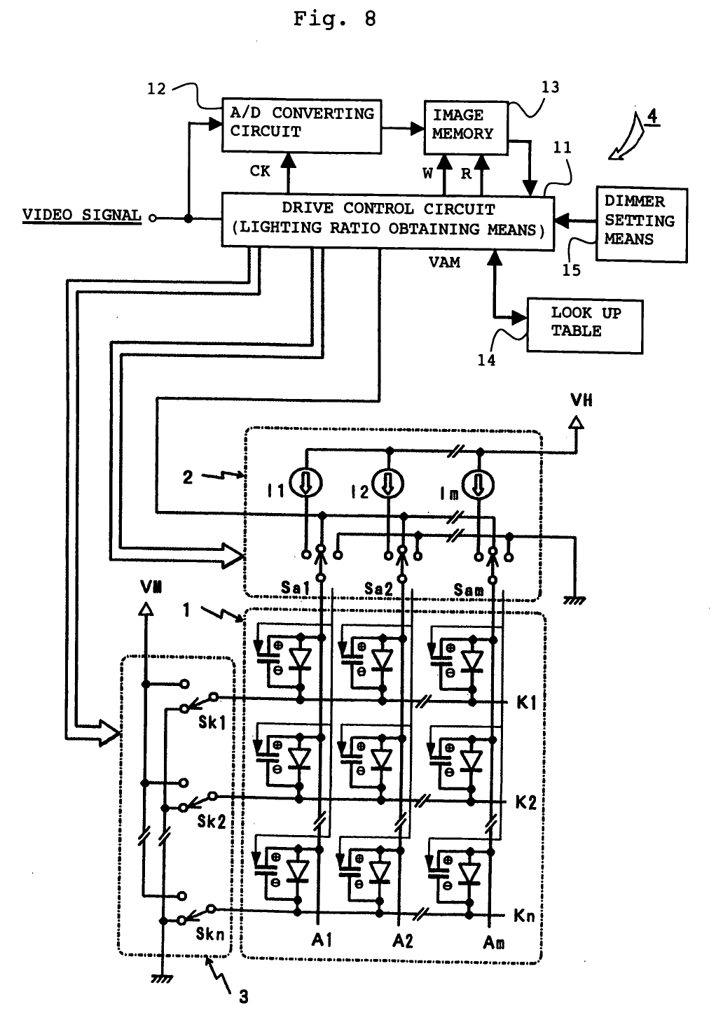

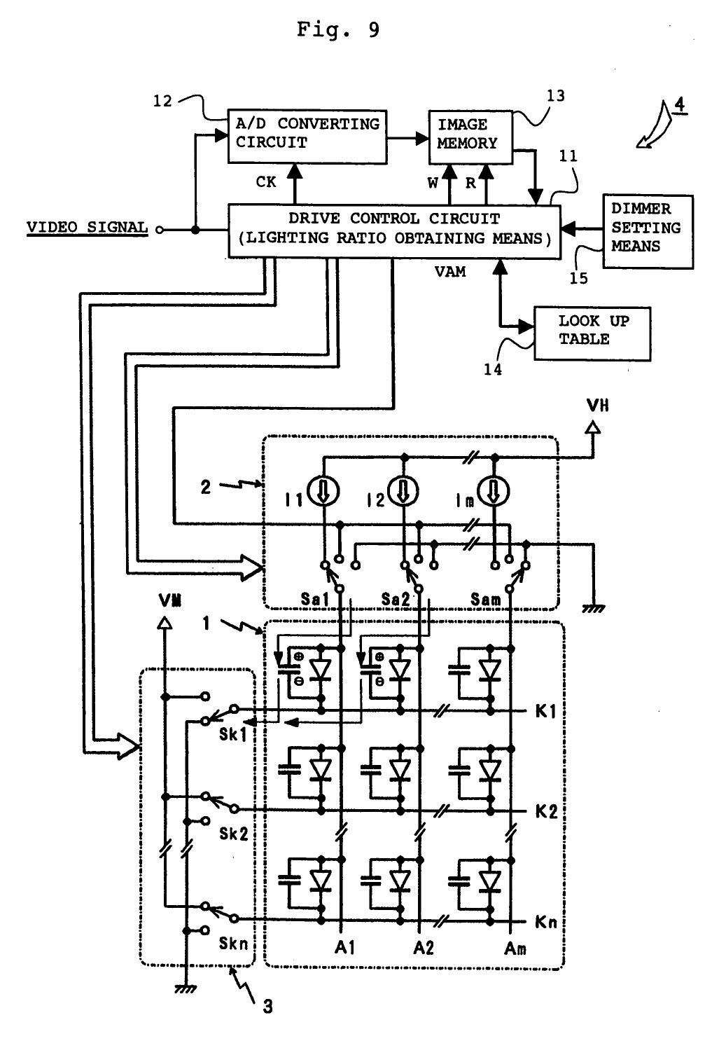

By this manner, the precharge voltage VAM controlled in response to the lighting ratio of EL elements for each one scan is supplied to the anodes of the respective EL elements via the respective drive switches Sa1-Sam as shown in FIG. 8, so that precharge for the parasitic capacitances of the respective EL elements is performed. The above-described operation is sequentially performed from the first to nth row of the scan lines in synchronization with the scan of the scan driver 3.

Accordingly, the value (level) of the precharge voltage VAM is each time controlled to be changed in response to the lighting ratio of EL elements for each one scan as shown as a-a′ in FIGS. 6B and 6C. Thus, as a result of the control for the level of the precharge voltage VAM in response to the occurrence rate of shadowing, this occurrence rate of shadowing generated due to the changes of the lighting ratio of EL elements can be reduced to a level at which this does not become a problem in practical use.

An optimum level of the precharge voltage VAM in response to the lighting ratio of EL elements of this case varies respectively due to a primary factor such as the entire parasitic capacitance of EL elements constituting the light emitting display panel, a panel size, the value of the above-mentioned reverse bias voltage VM, a reset means (the above-mentioned VM reset method or GND reset method), an image display pattern in the display panel, and the like. Therefore, it is necessary that the precharge control data corresponding to the lighting ratio which has been made in accordance with respective parameters as mentioned above be stored in the look up table 14.

The drive control circuit 11 operates to find the precharge control data in the look up table 14 from the lighting ratio PN for each one scan and the data of the dimmer setting (dimmer control data) as another aspect to supply the precharge voltage VAM based on the precharge control data which has been found from the look up table 14 to the data driver 2 shown in FIGS. 7-9.

Thus, the precharge voltage VAM based on the precharge control data which has been read out of the look up table 14 in accordance with the lighting ratio of EL elements for each one scan and the dimmer control data set at this time is supplied to the data driver 2. In this case, the look up table 14 is constructed like a map (two-dimensionally) by which the precharge control data can be drawn by the lighting ratio of the EL element and the dimmer control data. With such a structure, correction of shadowing due to the lighting ratio of the EL element can be performed effectively. Particularly occurrence of shadowing at a time of low dimmer can be restrained effectively.

In the aspects described above, although the value (level) of the precharge voltage VAM is controlled in response to the lighting ratio of EL elements for each one scan or along with the dimmer control data, instead of this, a precharge rate for the parasitic capacitances of EL elements may be controlled by controlling an applying time of a predetermined level of precharge voltage VAM.

That is, as shown as b-b′ in FIG. 6B, by controlling the precharge period in response to the lighting ratio of EL elements for each one scan or along with the dimmer control data, correction of shadowing due to the lighting ratio of EL elements can be performed. In addition, particularly occurrence of shadowing at a time of low dimmer can be restrained effectively.

Although the embodiments described above show an example in which organic EL elements are employed as light emitting elements arranged in the display panel, similar operations and effects can be obtained even in a case where other capacitive elements are employed as the light emitting elements. Although the above-described embodiments adopt a structure in which the precharge control data is read out of a look up table based on the lighting ratio of EL elements and the dimmer control data, a structure may be adopted in which the precharge control data is found through a logical operation.

What is claimed is:

1. A drive device of a light emitting display panel for implementing light emission drive for a passive matrix type display panel provided with a plurality of scan lines and a plurality of data lines which intersect one another and light emitting elements respectively connected between said respective scan lines and respective data lines at intersection positions between said respective scan lines and respective data lines, comprising a switching means of a scan driver side for setting said respective scan lines at a scan selection potential or a non-scan selection potential and a switching means of a data driver side for connecting said respective data lines to a lighting drive power source or a non-lighting drive power source, characterized in that at least a reset period, a precharge period, and a lighting period of said light emitting elements are set during one scan period of said display panel, and during said precharge period, a voltage from a precharge power source can be applied to said respective light emitting elements in a forward direction via all of said respective data lines and scan lines.

2. The drive device of the light emitting display panel according to claim 1, further comprising a lighting ratio obtaining means for obtaining the ratio of light emitting elements which should be controlled to emit light among said light emitting elements which are connected to said respective scan lines, wherein the value of a voltage supplied from said precharge voltage source is changed in response to a lighting ratio obtained through said lighting ratio obtaining means.

3. The drive device of the light emitting display panel according to claim 2, further comprising a dimmer control means for allowing said light emitting display panel to implement a dimmer display, wherein the value of the voltage supplied from said precharge power source is changed in response to the lighting ratio obtained through said lighting ratio obtaining means and dimmer control data employed in said dimmer control means.

4. The drive device of the light emitting display panel according to claim 1, further comprising a lighting ratio obtaining means for obtaining the ratio of light emitting elements which should be controlled to emit light among said light emitting elements which are connected to said respective scan lines, wherein an applying time for applying a voltage from said precharge voltage source to respective light emitting elements is changed in response to a lighting ratio obtained through said lighting ratio obtaining means.

5. The drive device of the light emitting display panel according to claim 4, further comprising a dimmer control means for allowing said light emitting display panel to implement a dimmer display, wherein an applying time for applying a voltage from said precharge voltage source to respective light emitting elements is changed in response to the lighting ratio obtained through said lighting ratio obtaining means and dimmer control data employed in said dimmer control means.

6. The drive device of the light emitting display panel according to claim 1, wherein a voltage value from said precharge power source is set at a value which does not exceed a voltage obtained by adding the light emission threshold voltage of said light emitting element to said scan selection potential.

7. The drive device of the light emitting display panel according to claim 1, wherein a voltage value from said precharge power source is set at a voltage value or higher which is obtained by adding the light emission threshold voltage of said light emitting element to said scan selection potential.

8. The drive device of the light emitting display panel according to claim 1, wherein said light emitting element is an organic EL light emitting element having an organic light emission functional layer composed of one or more layers between opposing electrodes.

9. A drive method of a light emitting display panel for implementing light emission drive for a passive matrix type display panel provided with a plurality of scan lines and a plurality of data lines which intersect one another and light emitting elements respectively connected between said respective scan lines and respective data lines at intersection positions between said respective scan lines and respective data lines, characterized in that at least a reset period, a precharge period, and a lighting period of said light emitting elements are set during one scan period of said display panel, and during said precharge period, a voltage from a precharge power source can be applied to said respective light emitting elements in a forward direction via all of said respective data lines and scan lines to implement a charge operation in which parasitic capacitances of said light emitting elements are charged in the forward direction.

10. The drive method of the light emitting display panel according to claim 9, wherein the ratio of said light emitting elements which should be controlled to emit light for each said one scan period is obtained through a lighting ratio obtaining means, and control is implemented such that the value of a voltage supplied from said precharge voltage source is changed in response to a lighting ratio obtained through said lighting ratio obtaining means.

11. The drive method of the light emitting display panel according to claim 10, wherein control is implemented such that the value of the voltage supplied from said precharge power source is changed in response to the lighting ratio obtained through said lighting ratio obtaining means and dimmer control data for allowing said light emitting display panel to implement a dimmer display.

12. The drive method of the light emitting display panel according to claim 9, wherein the ratio of light emitting elements which should be controlled to emit light for each said one scan period is obtained through a lighting ratio obtaining means, and control is implemented such that an applying time for applying a voltage from said precharge voltage source to respective light emitting elements is changed in response to a lighting ratio obtained through said lighting ratio obtaining means.

13. The drive method of the light emitting display panel according to claim 12, wherein control is implemented such that an applying time for applying a voltage from said precharge voltage source to respective light emitting elements is changed in response to the lighting ratio obtained through said lighting ratio obtaining means and dimmer control data for allowing said light emitting display panel to implement a dimmer display.

14. The drive method of the light emitting display panel as set forth in any one of claims 9 to 13, wherein a voltage value from said precharge power source is set at a value which does not exceed a voltage obtained by adding the light emission threshold voltage of said light emitting element to said scan selection potential.

15. The drive method of the light emitting display panel as set forth in any one of claims 9 to 13, wherein a voltage value from said precharge power source is set at a voltage value or higher which is obtained by adding the light emission threshold voltage of said light emitting element to said scan selection potential.
